(19) United States
(12) Patent Application Publication
(10) Pub. No.: US 2010/0114745 A1
(43) Pub. Date: May 6, 2010

(54) SYSTEM AND METHOD FOR CALCULATING AND APPLYING MARKET DATA CHANGE RATE SETS

(75) Inventors: Vinodh A. R., Chennai (IN); Sesha Srinivas Atchyutuni, Hyderabad (IN); Klaus Mueller, Neustadt (DE); Reinhard Poetzsch, Ubstadt-Weiher (DE)

Correspondence Address: KENYON & KENYON LLP, RIVERPARK TOWERS, SUITE 600, 333 W. SAN CARLOS ST., SAN JOSE, CA, 95110, US

(73) Assignee: SAP AG, Walldorf (DE)

(21) Appl. No.: 12/262,056

(22) Filed: Oct. 30, 2008

(51) Int. Cl. G06Q 40/00

(52) U.S. Cl. 705/35

(57) ABSTRACT

A system and method for simulating development of market data. In an embodiment, a set of market data change rates are calculated from historical market data values. The set of calculated market data change rates is then applied to a market data start value to generate one or more forecast market data values, each forecast market data value associated with a horizon date.

### CROSS-REFERENCE TO RELATED APPLICATIONS

This application is related to U.S. patent application Ser. No. 12199775, filed Aug. 27, 2008, entitled “System and Method for Exposure Management.”

### COPYRIGHT AND LEGAL NOTICES

A portion of the disclosure of this patent document may contain material which is subject to copyright protection. The copyright owner has no objection to the facsimile reproduction by anyone of the patent document or the patent disclosure as it appears in the Patent and Trademark Office patent files or records, but otherwise reserves all copyrights whatsoever.

### BACKGROUND

Business entities, e.g., banks, enter into a large number of transactions in the ordinary course of their operations. Some of these transactions carry financial risks such as currency or foreign exchange (FX) risks, commodity price risks, interest rate risks, stock price risks, and counterparty risks, to name a few. For example, individual loans carry the risk of debtor default, currency exchange rate fluctuations, or changing interest rates for variable rate loans or imminently mature loans (whose principal likely will be reinvested at a new interest rate). Financial risks are often affected by market data changes such as changing costs or currency values. For example, an increased or decreased value of the U.S. Dollar relative to the Euro affects FX risks in transactions involving those currencies. As another example, an increased or decreased cost of a commodity like aluminum, copper, gold, or oil affects the commodity price risks for that commodity.

Typically, the business entities' internal policies or banking regulations of governing regulatory bodies, e.g., the International Accounting Standards Board (IASB), which has promulgated International Financial Reporting Standard (IFRS) 39, Financial Instruments: Recognition and Measurement, or the Financial Accounting Standards Board (FASB), which has promulgated Financial Accounting Statement (FAS) 133, Accounting for Derivative Instruments and Hedging Activities, require, at least in some instances, that the business entities own instruments, typically derivatives such as options, whose behavior counterbalances risks presented by the transactions. This is called “hedging.”

Risk exposures presented by a first, typically numerically large, set of instruments are counterbalanced by performance of a second, typically much smaller, set of instruments (called “hedging instruments” herein), such that when risk rises with respect to the instruments that present the risk exposures, risk falls in the hedging instruments. For example, a set of instruments are grouped and treated as a single exposure that is to be hedged. One or more hedging instruments counterbalance the exposure group. The exposures or exposure groups and their corresponding hedging instruments are grouped into corresponding hedging relationships. A hedging relationship associates one or more particular hedging instruments with a particular exposure or exposure group. Accordingly, use of hedging relationships aids in management of risk exposures and corresponding hedging instruments and facilitates compliance with hedging policies or regulations.

Additionally, the business entities' internal policies or banking regulations of governing regulatory bodies such as the IASB or FASB typically require, at least in some instances, that the business entities prospectively test their risk exposure management strategies (for example, the effectiveness of their hedging instruments) by simulating future market data. Both short-term (e.g., 5-30 days) and long-term (e.g., 2-10 years) market data are relevant to risk exposure management; thus, market data forecast models should accurately simulate both short- and long-term trends to improve hedging effectiveness.

Previous strategies for simulating future market data, however, do not accurately preserve correlation values—for example, the relationship between the price of oil and the relative strength of the U.S. Dollar versus the Euro—while accurately accounting for short- and long-term trends. For example, extrapolating historical data into the future maintains correlation values but ignores short-term trends. On the other hand, the well-known Monte Carlo modeling method preserves correlation values in the short term but is too noise-sensitive (that is, too easily influenced by random irrelevant or meaningless data) to accurately model long-term trends. A hybrid approach generates a Monte Carlo model while assuming a steady market data change rate, but this model sacrifices correlation value accuracy.

Available computer applications employ improved strategies for simulating future market data. For example, existing applications may employ scenarios, which forecast future market data based on hypothetical values at specific times input by the user. For example, a user may assume that the Dow Jones Industrial Average closes at 11500 in 5 days. Based on that assumption (i.e., “scenario”) and current market data, the application might calculate a market data change rate and apply it to predict, for example, the value of the U.S. Dollar relative to the Euro at the Dow's close in 5 days. The user, however, must manually enter his or her assumptions. Moreover, since scenarios are calculated from absolute values, an output value may not be “reused”; that is, although a user may create a model based on multiple assumptions, he may not use that model to create another model based on new or different assumptions. For example, a user may design a scenario that predicts the price of oil in 5, 10, and 15 days based on certain values; that scenario, however, is useless to predict the price of oil in 20 days. The user must instead enter new hypothetical values and rerun the scenario application. Existing applications may also employ “shifts,” which apply mathematical formulae to current market data to predict market data values for a particular time in the future. Like scenarios, shifts require manual entry of data, assumptions, and/or formulae.

Even these improved strategies, however, are ill-suited to hedging or risk management. For example, these strategies may employ random values to simulate the market's reaction to, for example, strategy changes within a company. In this case, the same input set may yield different output sets upon multiple executions. This lack of reproducibility may cause auditing difficulties, especially if a business entity's hedging percentage (i.e., the percent of financial risk that is hedged) is low (for example, 85% or less). In addition, any data for documentation or auditing may be stored in the application, not the system, resulting in more storage space consumed.

More complex strategies maintain correlation values while applying them to current market data; however, these strategies require continually rebuilding the model to reflect the latest market data. Thus, applications which employ these complex strategies consume massive resources and are appropriate only for the most sophisticated users, such as, for example, brokerage firms.

The common business user thus requires a simpler, more efficient solution which simulates both short- and long-term development of market data while preserving correlation values.

### SUMMARY OF INVENTION

Embodiments of the present invention enable users to maintain market data change rate (“MDCR”) information for different risk factors using a unified interface. In example embodiments, a single interface may facilitate maintaining, storing, and/or retrieving market data. Embodiments of the present invention may further provide access to historical market data and/or simulate future market data.

### BRIEF DESCRIPTION OF THE DRAWINGS

FIG. 1 is a block diagram of a system and method according to an embodiment of the present invention.

FIG. 2 illustrates an example time-model for simulating the development of future market data, according to an embodiment of the present invention.

FIG. 3 is a flow chart that illustrates an example procedure performed to simulate FX scenario values, according to an embodiment of the present invention.

FIG. 4 illustrates an example calculation of FX scenario values, according to an embodiment of the present invention.

FIG. 5 is a flow chart that illustrates an example procedure performed to simulate stock scenario values, according to an embodiment of the present invention.

FIG. 6 is a flow chart that illustrates an example procedure performed to convert a dividend schedule into its corresponding stock scenario currency, according to an embodiment of the present invention.

FIG. 7 illustrates an example calculation of stock scenario values, according to an embodiment of the present invention.

### DETAILED DESCRIPTION

Embodiments of the present invention relate to a market data solution which may handle at least one of: extracting and storing historical information, calculating market data change rate sets, and/or applying market data change rate sets to forecast future market data.

Embodiments of the present invention enable a customer to manage historical market data and simulate long-term development of future market data. In example embodiments, these simulations may be used to predict, for example, the fair market value of a currency or commodity at a given time in the future. In example embodiments, these simulations may also model, for example, how market data changes affect risk exposure positions. Because they implicitly preserve correlation values and produce consistent results when repeated with identical input, example embodiments of the present invention are well-suited for testing hedging and risk management strategies while providing the reproducibility desired for auditing.

Embodiments of the present invention further provide a central storage place for market data, eliminating the need for data replication in each application. The tool is flexible and may be easily enhanced or adapted to existing or future customer systems, such as customer planning and production systems. In example embodiments, the tool provides seamless integration into existing hedge accounting solutions in compliance with, e.g., IFRS 39 or FAS 133. In an embodiment, the tool provides seamless integration into the analytical components of Treasury and Risk Management, which makes both internal operational Risk Management and external Risk Reporting (e.g., according to IFRS 7, Financial Instruments Disclosures) more efficient and accessible.

For purposes of illustration, the below example embodiments of the present invention largely concern stock price and foreign exchange (FX) risks. However, the embodiments may be used for other purposes as would be evident to one of skill in the art. For example, embodiments of the present invention may manage or simulate all kinds of risks, such as financial risks including foreign exchange risk, interest rate risk, commodity price risk, stock price risk and counterparty risk.

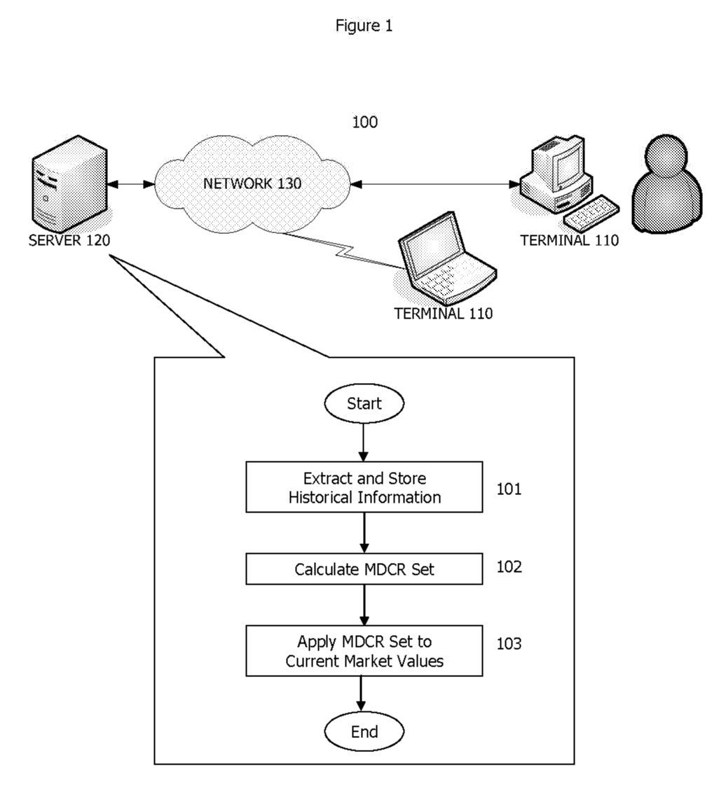

FIG. 1 is a simplified block diagram of a system 100 according to an embodiment of the present invention. As shown, the system 100 may include one or more computer terminals 110 coupled to one or more servers 120 via a network 130. The terminals 110 provide user interface points at which users may interact with the system to view and manage market data. The system may be programmed to transform historical and/or current market data into models that simulate future market behavior, for example as in steps 101-103.

In step 101, example embodiments of the present invention extract and store historical market data. The data may be extracted from one or more sources of financial data according to any method known in the art. Alternatively, some or all historical market data may be manually entered into the system.

In step 102, example embodiments of the present invention generate market data change rate (“MDCR”) sets, which model market data values as change rates over given periods. As contemplated by embodiments of the present invention, an MDCR set may include market data change rates (“MDCR data points”) generated from the same historical market data. As an example, one MDCR data point may indicate that the price of oil is forecast to increase by 3% annually over the next 180 days. Another MDCR data point may indicate that the Euro is forecast to gain 2% relative to the U.S. Dollar in the next 180 days. Still another MDCR data point may indicate that the price of oil is forecast to decrease by 4% over the next 365 days, and so on. By thus reflecting relative changes, the model implicitly preserves correlation values. For example, the model could preserve the correlation between the price of oil and the relative strength of the U.S. Dollar versus the Euro while accurately modeling long-term trends.

In example embodiments, the system extrapolates historical market data (for example, the data stored in step 101) using, for example, the well-known Elliott wave principle. In this way, the model simulates development curves and cycles while ignoring short-term tremors caused, for example, by day-trading. Similarly, example embodiments incorporate any random values employed by the formulae into the forecast change rate, resulting in a condensed and, therefore, repeatable value that may be archived for auditing purposes. Moreover, by assigning each MDCR set a unique identifier, embodiments of the present invention may enable automatic versioning of forecast data.

In step 103, example embodiments of the present invention apply one or more of the MDCR sets calculated in step 102 to known or hypothetical market values, such as to current market data. In this way, embodiments of the present invention may forecast, for example, the fair market value of a hedging instrument over a period of time. Since example embodiments apply forecast values independently, the system need not generate new MDCR sets for each data point to be forecast. Rather, the system may calculate MDCR sets periodically (e.g., monthly) but apply them as demanded by daily use. Thus, decoupling the calculation (step 102) and application (step 103) of MDCR sets not only facilitates versioning and archiving of forecast market data but also results in faster execution since the MDCR calculation is performed less frequently. To that end, embodiments of the present invention initially calculate a constant rate of return over a long period, for example from 1920 through 1988. As new market data is extracted into the system, embodiments of the present invention periodically generate and store MDCR sets from the new data into the system. As the new MDCR sets are generated and stored, embodiments of the present invention annualize or otherwise combine the stored change rates, creating condensed MDCR sets which may be applied to subsequent market data.

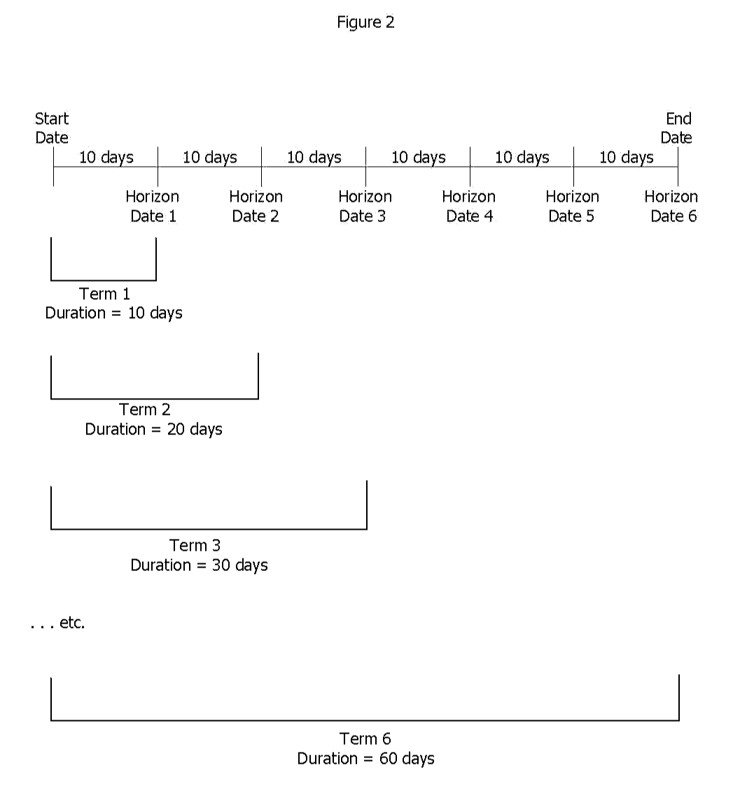

FIG. 2 illustrates an example time-model for simulating the development of future market data as in steps 102 and 103. Such a model may be used, for example, to simulate a hedging relationship, wherein the Start Date represents the current date, and the End Date represents the end of the hedging relationship. In this example, the model period is divided into six Terms, where each Term is defined as the period between the Start Date and one of six Horizon Dates, the last of which coincides with the End Date. In example embodiments, the Horizon Dates are equidistant. Thus, in the illustrated example, the duration of Term 1 (between the Start Date and Horizon Date 1) would be 10 days, the duration of Term 2 (between the Start Date and Horizon Date 2) would be 20 days, the duration of Term 3 (between the Start Date and Horizon Date 3) would be 30 days, and so forth through Term 6 (between the Start Date and the End Date, i.e., Horizon Date 6), whose duration would be 60 days.

For illustration purposes, the example in FIG. 2 simulates a period of 60 days, divided into six Terms. It should be understood, however, that hedging relationships may last much longer, for example five to ten years. In that case, example embodiments would divide the hedging relationship period into many more Terms. For example, if a hedging instrument comprised futures on oil with delivery in ten years, an example embodiment might divide the hedging relationship period (ten years) into 50 Terms instead of the six depicted in FIG. 2.

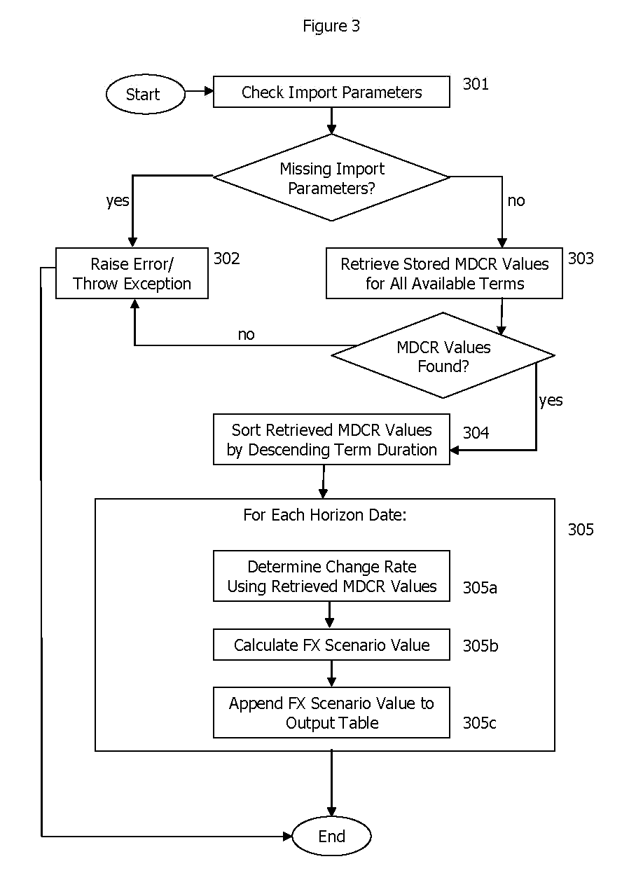

FIG. 3 illustrates an example procedure performed to simulate FX scenario values as in step 103 of FIG. 1, according to an embodiment of the present invention. As used herein, “FX scenario value” means a forecast foreign exchange rate between two particular currencies at a particular time given particular input. In example embodiments, the procedure uses the time-model illustrated in FIG. 2 to generate a schedule of forecast foreign exchange rate values.

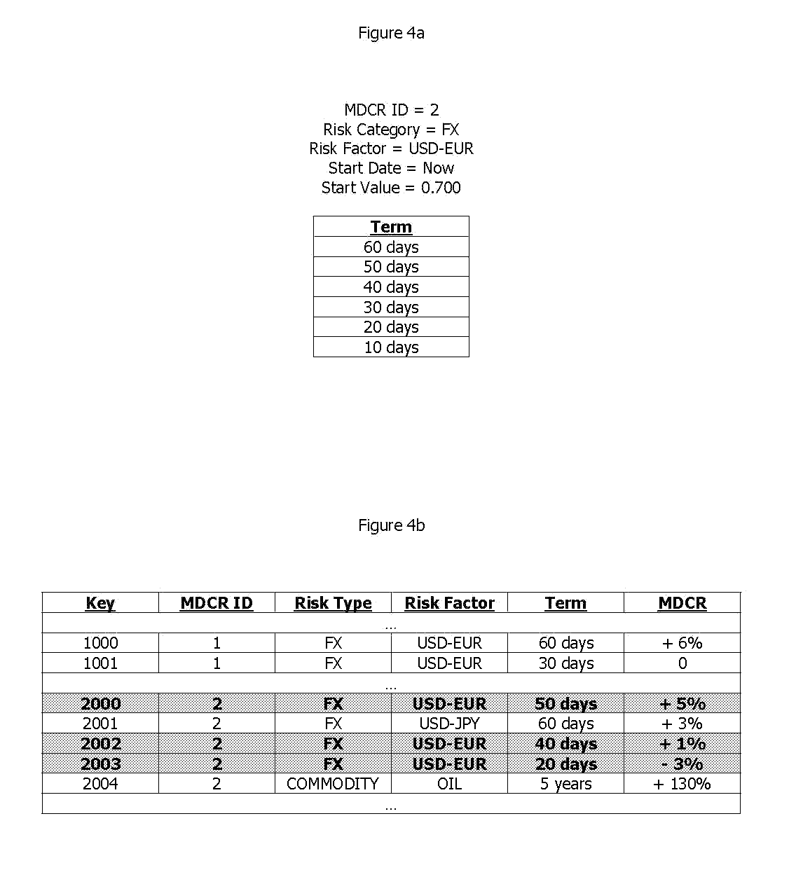

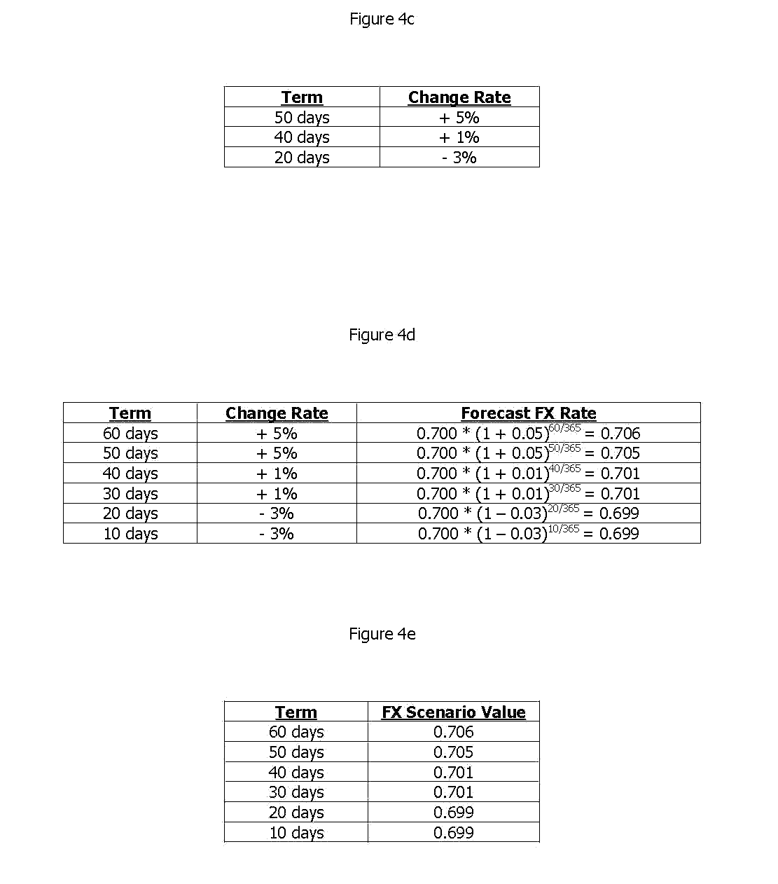

In step 301, the system checks to ensure that all required input parameters are present. As an example, a procedure to simulate FX scenario values may require as input: a pointer to one or more MDCR sets (as, for example, calculated and stored in step 102 of FIG. 1); information about which risk to model (for example, FX from USD to EUR); the dates, including the Start Date, to simulate; and a Start Value representing actual or hypothetical market data for the Start Date. Example embodiments provide as input a Horizon Table representing the Terms to be modeled. FIG. 4a illustrates example input for simulating the USD-EUR exchange rate using MDCR Set 2 for the dates shown in FIG. 2, where the Start Date is the current date and the Start Value (i.e., the current USD-EUR exchange rate) is 0.700. If any input parameters are missing or invalid, then the system raises an error and/or throws an exception as shown in step 302, and the process ends. Otherwise, the system retrieves the stored MDCR values which correspond to the input into an MDCR Value Table, as shown in step 303. In the above example and given the data set shown in FIG. 4b, the system would select the stored MDCR values in rows 2000, 2002, and 2003, which contain USD-EUR FX data in MDCR Set 2. If no corresponding MDCR values are found in step 303, then the system raises an error and/or throws an exception as shown in step 302, and the process ends. Otherwise, the system sorts the MDCR Value Table by descending Term Duration, as shown in step 304 and illustrated in FIG. 4c.

In step 305, the system calculates the FX scenario value for each Horizon Date. First, the system determines a change rate c for each Term in the Horizon Table, as shown in step 305a. In an example embodiment, the change rate c for a Horizon Table Term of Δt days is the change rate of the shortest MDCR Value Table Term that is greater than or equal to Δt days; if no MDCR Value Table Term is greater than or equal to Δt days, then the change rate c for that Horizon Table Term is the change rate of the longest MDCR Value Table Term. In an alternative embodiment, the change rate c for a Horizon Table Term of Δt days is the change rate of the longest MDCR Value Table Term that is shorter than or equal to Δt days; if no MDCR Value Table Term is shorter than or equal to Δt days, then the change rate c for that Horizon Table Term is the change rate of the shortest MDCR Value Table Term. Returning to the above example, if the MDCR Value Table contained change rates of +5%, +1%, and −3% for Terms of 50, 40, and 20 days, respectively, as shown in FIG. 4c, then the change rates for each Term in the Horizon Table would equal those shown in the “Change Rate” column of FIG. 4d, according to an example embodiment. However, embodiments of the present invention contemplate many ways to calculate the change rate c, including by interpolating and/or extrapolating from MDCR Value Table data, possibly while considering current market data change rates.

In step 305b, the system uses the change rate c determined in step 305a to calculate an FX scenario value for each Horizon Date. Example embodiments calculate the FX scenario value using a compound change rate formula, wherein the change rate compounds daily, i.e., for a Term of Δt days:

Scenario_Value(Δt)=Start_Value*(1+c)^{Δt/365}

Returning to the example in FIG. 4, this calculation is illustrated in the “Forecast FX Rate” column of FIG. 4d.

In step 305c, the system appends the FX scenario value calculated in step 305b to an output table, for example as shown in FIG. 4e. In this way, the process returns a forecast foreign exchange rate schedule between two particular currencies at a particular time given particular input.

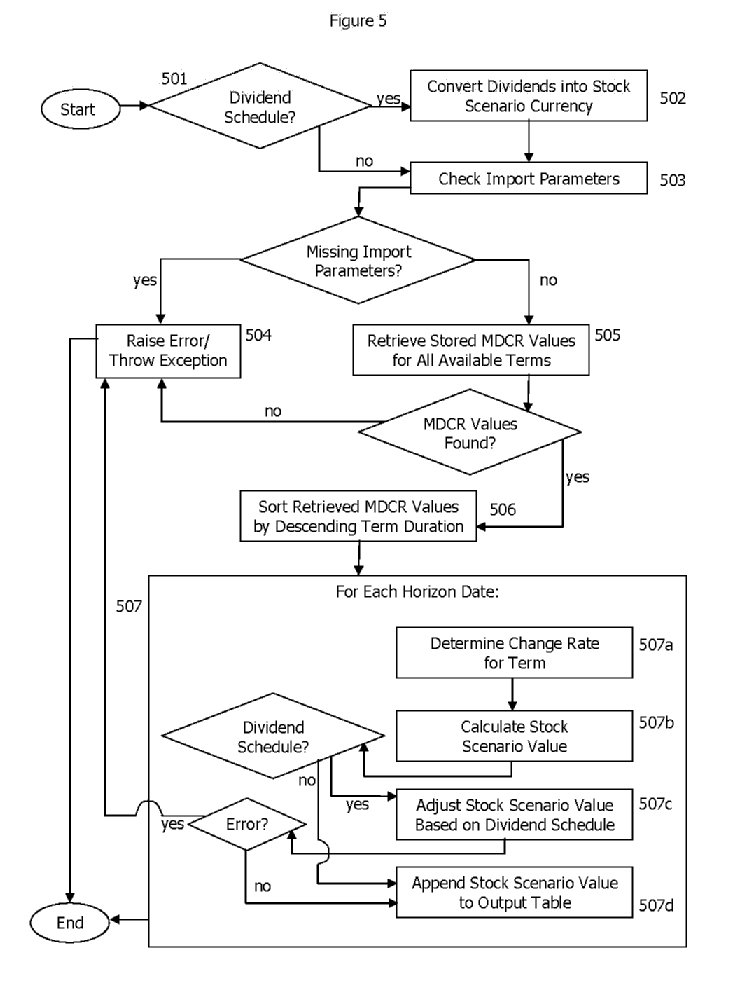

As another example, FIG. 5 illustrates an example procedure performed to simulate stock scenario values as in step 103 of FIG. 1, according to an embodiment of the present invention. As used herein, “stock scenario value” means a forecast market price for a particular stock (or group of stocks) at a particular time given particular input. In example embodiments, the procedure uses the time-model illustrated in FIG. 2 to generate a schedule of forecast stock price values. Example embodiments may further convert between currencies using appropriate FX scenario rates, for example if the currency of a dividend schedule differs from the currency of the given stock.

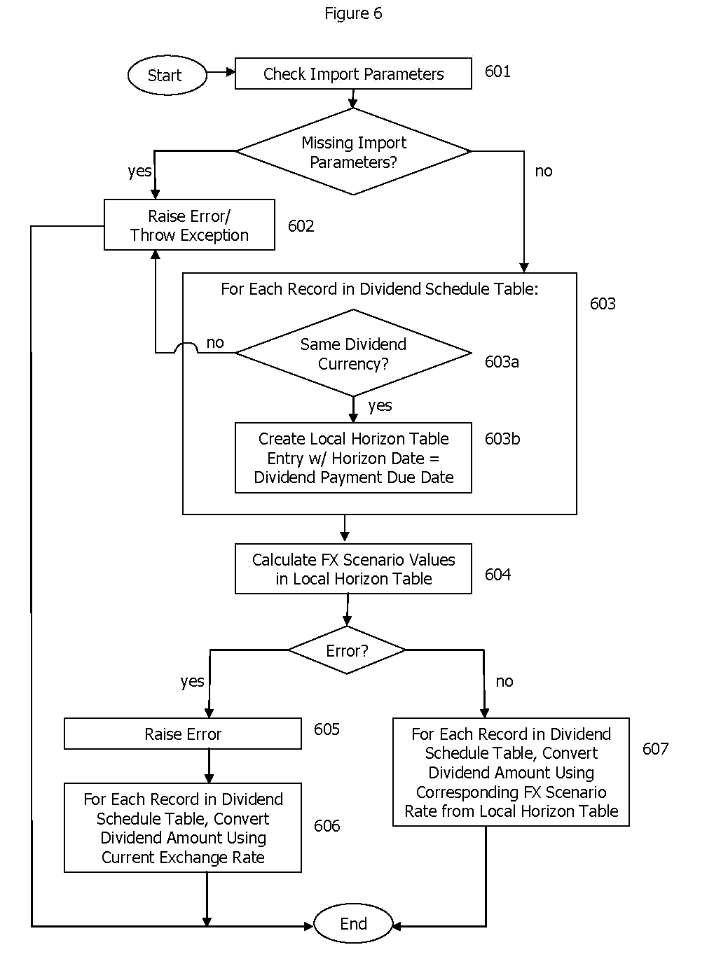

In step 501, example embodiments of the present invention determine whether a dividend schedule exists for the given stock. If so, the system converts the dividend schedule into the given stock's currency, as shown in step 502. FIG. 6 illustrates an example process for this conversion which uses a forecast FX rate schedule to convert each dividend payment using its corresponding forecast foreign exchange rate.

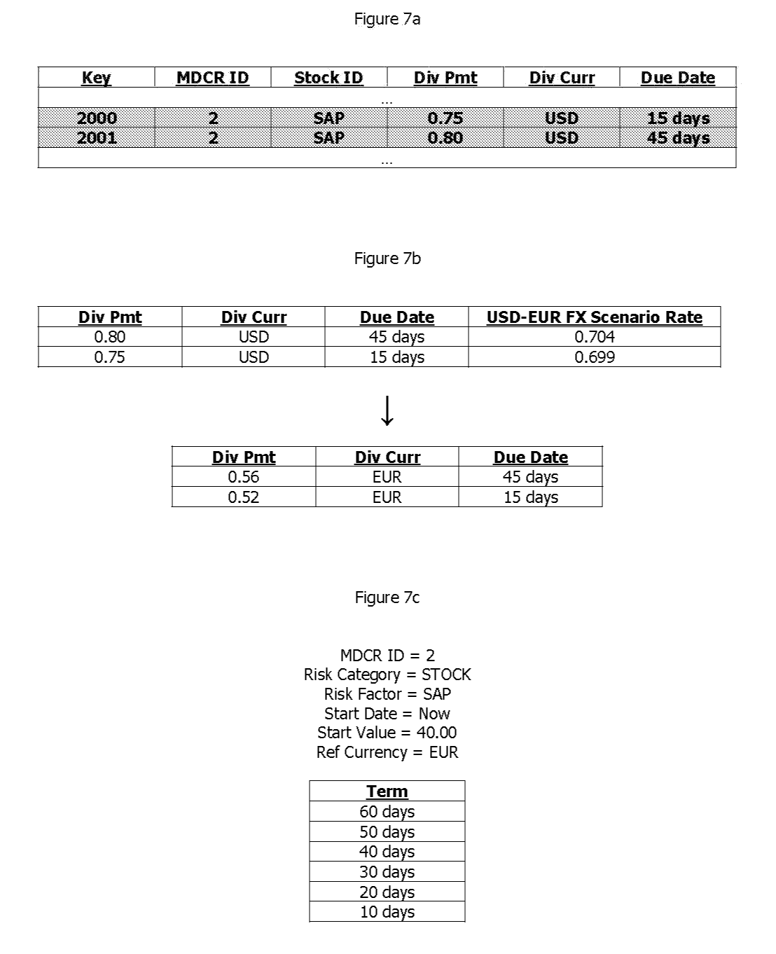

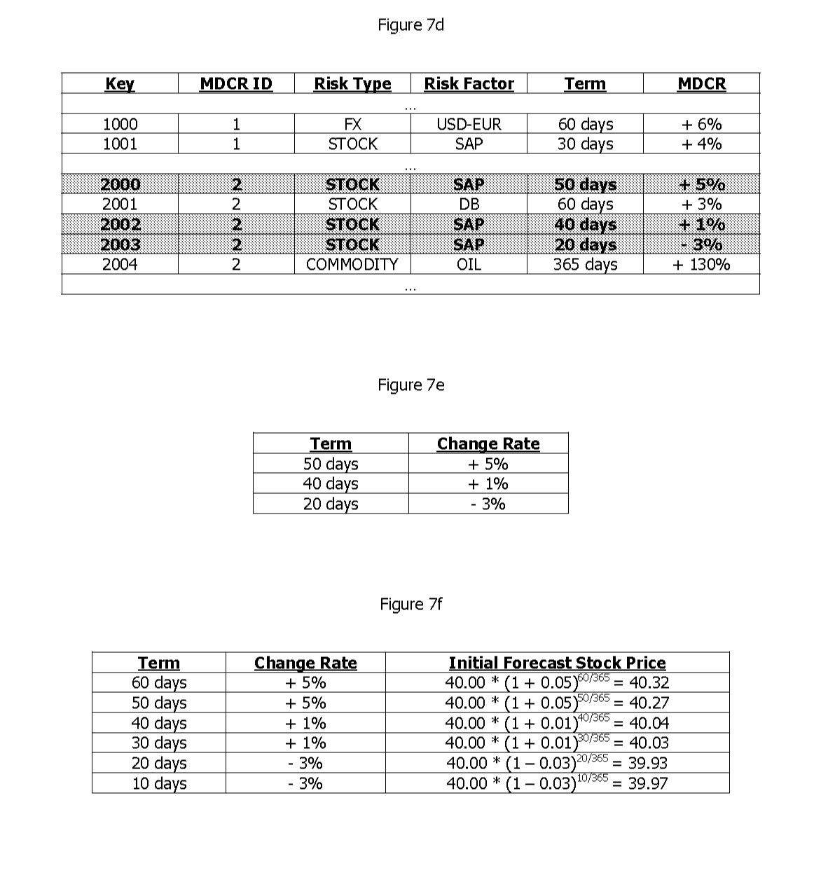

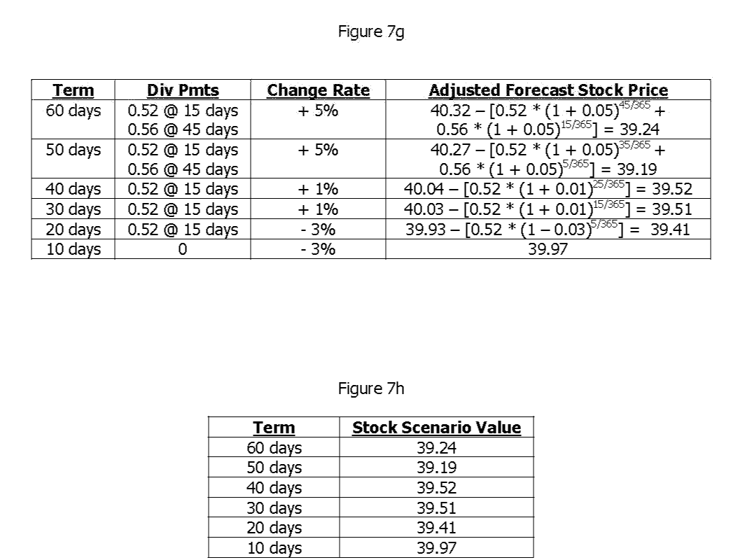

In step 601, the system checks the input parameters to ensure that all required data to convert the dividend schedule is present. For example, in addition to the schedule itself (as shown, for example, in FIG. 7a), embodiments of the present invention may require one or more of: a Start Date for the simulation (as shown, for example, in FIG. 2); a pointer to the MDCR set(s) under consideration; and the currency to which the dividend schedule should be converted. If any input parameters are missing or invalid, then the system raises an error and/or throws an exception as shown in step 602, and the process ends.

If all input parameters are valid, then the system creates a local Horizon Table wherein each Horizon Date corresponds to a dividend payment due date in the dividend schedule table, as shown in step 603. Example embodiments first verify that the dividend schedule table contains only one currency from which to convert, as shown in step 603a. If a second currency is found in the dividend schedule table, then the system raises an error and/or throws an exception as shown in step 602, and the process ends. Otherwise, the system traverses through each record in the dividend schedule table, creating a corresponding local Horizon Table entry, as shown in step 603b.

In step 604, the system calculates the FX scenario value for each record in the local Horizon Table, for example using the process illustrated in FIGS. 3-4 and described above. If the FX scenario value calculation process returns an error, then the current process raises an error as shown in step 605. It then uses the current foreign exchange rate between the dividend schedule currency and the given stock's currency to convert each record in the dividend schedule table to the given stock's currency, as shown in step 606. If, on the other hand, the FX scenario value calculation process shown in step 604 completes without error, then the current process converts each record in the dividend schedule table to the given stock's currency using the corresponding FX scenario rate from the local Horizon Table, as shown in step 607. As an example, FIG. 7b illustrates the conversion of the dividend schedule data selected in FIG. 7a from USD to EUR using the input and data shown in FIG. 4a-b.

Returning to FIG. 5, in step 503, the system checks to ensure that all required input parameters are present. As an example, a procedure to simulate stock scenario values may require as input: a pointer to one or more MDCR sets (as, for example, calculated and stored in step 102 of FIG. 1); information about which risk to model (for example, stock price risk for SAP AG stock); the dates, including the Start Date, to simulate; a Start Value representing actual or hypothetical market data for the Start Date; and the currency in which the Start Value is represented. Example embodiments provide as input a Horizon Table representing the Terms to be modeled. FIG. 7c illustrates example input for simulating SAP AG stock using MDCR Set 2 for the dates shown in FIG. 2, where the Start Date is the current date and the Start Value (i.e., the current SAP AG stock price) is 40.00 [symbol] . If any input parameters are missing or invalid, then the system raises an error and/or throws an exception as shown in step 504, and the process ends. Otherwise, the system retrieves the stored MDCR values which correspond to the input into an MDCR Value Table, as shown in step 505. In the above example and given the data set shown in FIG. 7d, the system would select the stored MDCR values in rows 2000, 2002, and 2003, which contain SAP AG stock price data in MDCR Set 2. If no corresponding MDCR values are found in step 505, then the system raises an error and/or throws an exception as shown in step 504, and the process ends. Otherwise, the system sorts the MDCR Value Table by descending Term Duration, as shown in step 506 and illustrated in FIG. 7e.

In step 507, the system calculates the stock scenario value for each Horizon Date. First, the system determines a change rate c for each Term in the Horizon Table, as shown in step 507a. In an example embodiment, the change rate c is calculated in the same manner as described in step 305a above. Returning to the above example, if the MDCR Value Table contained change rates of +5%, +1%, and −3% for Terms of 50, 40, and 20 days, respectively, as shown in FIG. 7e, then the change rates for each Term in the Horizon Table would equal those shown in the “Change Rate” column of FIG. 7f. However, embodiments of the present invention contemplate many ways to calculate the change rate c, including by interpolating and/or extrapolating from MDCR Value Table data, possibly while considering current market data change rates.

In step 507b, the system uses the change rate c determined in step 507a to calculate an initial stock scenario value for each Horizon Date. Example embodiments calculate the initial stock scenario value in the same manner as described in step 305b above, i.e., for a Term of Δt days:

Init_Scenario_Value(Δt)=Start_Value*(1+c)^{Δt/365}

Returning to the example in FIG. 7, this calculation is illustrated in the “Initial Forecast Stock Price” column of FIG. 7f.

If a dividend schedule exists for the given stock, then the system next adjusts the stock scenario value based on the dividend schedule, as shown in step 507c. Example embodiments use the converted dividend schedule generated in step 502 to calculate an adjusted scenario value by subtracting each dividend payment Dᵢ due at Δtᵢ during the Term, i.e., where Start_Date<Δtᵢ<Δt. An example embodiment also subtracts the compounding effect of each Dᵢ. That is, Scenario_Value(Δt)=

$$Init\_Scenario \_Value ( Δ t ) - {\sum }_{Δ {t}_{i} ∈ \{ 0 , Δ t \}} [ {D}_{i} \times {( 1 + c )}^{( Δ t - Δ {t}_{i} ) / 365} ]$$

Returning to the example in FIG. 7, this calculation is illustrated in the “Adjusted Forecast Stock Price” column of FIG. 7g.

If the system encounters an error while calculating the adjusted stock scenario value (for example, if the converted dividend currency differs from the reference currency assigned to the risk factor), then it returns an error and/or throws an exception as shown in step 504, and the process ends. If step 507c completes without error, or if no dividend schedule exists for the given stock, then the system appends the stock scenario value calculated in step 507b or 507c to an output table, as shown in step 507d and illustrated, for example, in FIG. 7h. In this way, the process returns a forecast market price for a particular stock (or group of stocks) at a particular time given particular input.

Returning to FIG. 1, the market data will typically be calculated and maintained by applications executing on the servers 120 although, in some instances, such applications will execute on the terminals 110. The network 130 provides a communication medium between the terminals 110 and the servers 120, which may exchange communication between network components according to wired and/or wireless protocols. A variety of network topologies are well known for such computer systems 100; the number of terminals 110, the number of servers 120, and differences in network topologies are immaterial to the foregoing description unless mentioned above.

Likewise, those skilled in the art can appreciate from the foregoing description that the present invention can be implemented in a variety of forms. For example, the above embodiments may be used in various combinations with and without each other. Therefore, while the embodiments of the present invention have been described in connection with particular examples thereof, the above embodiments are for illustration purposes only and are not meant to limit the scope of the present invention. Other modifications will become apparent to the skilled practitioner upon a study of the present application.

What is claimed is:

1. A method for simulating development of market data from a start date to an end date, comprising:
calculating a set of at least one market data change rate from at least two historical market data values,
each historical market data value associated with a date on or before the start date,
each calculated market data change rate associated with a term from the start date; and
applying at least one of the calculated market data change rates to a market data start value associated with the start date to generate one or more forecast market data values, each forecast market data value associated with a horizon date after the start date and on or before the end date.

2. The method of claim 1, further comprising extracting and storing the historical market data values from one or more sources of financial data.

3. The method of claim 1 wherein calculating the set of market data change rates comprises extrapolating from two or more of the historical market data values.

4. The method of claim 1, further comprising storing the set of market data change rates.

5. The method of claim 4, further comprising assigning a unique identifier to the stored set of market data change rates.

6. The method of claim 4, further comprising:
combining the stored set of market data change rates with a second stored set of market data change rates to create a third set of market data change rates, each market data change rate in the third set associated with a term from a second start date; and
applying at least one of the market data change rates in the third set to a second market data start value to generate one or more second forecast market data values, each second forecast market data value associated with a horizon date after the second start date and on or before a second end date.

7. The method of claim 4 wherein applying the calculated market data change rates to the market data start value comprises:
retrieving one or more of the stored market data change rates;
using one or more of the retrieved market data change rates to determine a change rate corresponding to each horizon date; and
using each determined change rate to generate the forecast market data value associated with the horizon date corresponding to that determined change rate.

8. The method of claim 7 wherein the determined change rate corresponding to a horizon date is the retrieved market data change rate associated with one of the shortest term ending after the horizon date or the longest term ending before the horizon date.

9. The method of claim 7 wherein the determined change rate is interpolated or extrapolated from two or more retrieved market data change rates.

10. The method of claim 7 wherein the forecast market data value is generated using a compounding change rate formula.

11. The method of claim 1 wherein the market data start value comprises hypothetical market data.

12. The method of claim 1 wherein the market data start value comprises current market data.

13. The method of claim 1 wherein the horizon dates are equally distributed from the start date through and including the end date.

14. A system for simulating development of market data, comprising:
a database;
a processor; and
a computer-readable storage medium storing instructions to be executed by the processor, which instructions, when executed, perform a method for simulating development of market data, the method comprising:
calculating a set of at least one market data change rate from at least two historical market data values,
each historical market data value associated with a date on or before the start date,
each calculated market data change rate associated with a term from the start date; and
applying at least one of the calculated market data change rates to a market data start value associated with the start date to generate one or more forecast market data values, each forecast market data value associated with a horizon date after the start date and on or before the end date.

15. The system of claim 14 wherein the method further comprises:
extracting the historical market data values from one or more sources of financial data; and
storing the historical market data values in the database.

16. The system of claim 14 wherein calculating the set of market data change rates comprises extrapolating from two or more of the historical market data values.

17. The system of claim 14 wherein the method further comprises storing the set of market data change rates in the database.

18. The system of claim 17 wherein the method further comprises assigning a unique identifier to the stored set of market data change rates.

19. The system of claim 17 wherein the method further comprises:
combining the stored set of market data change rates with a second stored set of market data change rates to create a third set of market data change rates, each market data change rate in the third set associated with a term from a second start date; and
applying at least one of the market data change rates in the third set to a second market data start value to generate one or more second forecast market data values, each second forecast market data value associated with a horizon date after the second start date and on or before a second end date.

20. The system of claim 17 wherein applying the calculated market data change rates to the market data start value comprises:
retrieving one or more of the stored market data change rates;
using one or more of the retrieved market data change rates to determine a change rate corresponding to each horizon date; and
using each determined change rate to generate the forecast market data value associated with the horizon date corresponding to that determined change rate.

21. The system of claim 20 wherein the determined change rate corresponding to a horizon date is the retrieved market data change rate associated with one of the shortest term ending after the horizon date or the longest term ending before the horizon date.

22. The system of claim 20 wherein the determined change rate is interpolated or extrapolated from two or more retrieved market data change rates.

23. The system of claim 20 wherein the forecast market data value is generated using a compounding change rate formula.

24. The system of claim 14 wherein the market data start value comprises hypothetical market data.

25. The system of claim 14 wherein the market data start value comprises current market data.

26. The system of claim 14 wherein the horizon dates are equally distributed from the start date through and including the end date.
